(19) United States
(12) Patent Application Publication
(10) Pub. No.: US 2012/0098383 A1
(43) Pub. Date: Apr. 26, 2012

(54) Electric Machine Having a Brush-Slip Ring Device

(76) Inventors: Alexander Kunz, Heidenheim (DE); Günter Zwarg, Berlin (DE)

(21) Appl. No.: 13/264,735

(22) PCT Filed: Apr. 16, 2010
(86) PCT No.: PCT/EP2010/002331

§ 371 Date: Dec. 30, 2011

(30) Foreign Application Priority Data
Apr. 30, 2009 (DE) 10 2009 019 295.6

(51) Int. Cl. H02K 9/28

(52) U.S. Cl. 310/227

(57) ABSTRACT

The invention relates to an electric machine, comprising
a stator;
a rotor carried by a shaft;
a brush-slip ring device, the slip ring of which encloses the shaft and is connected with said shaft in a torsion-proof manner;
a cooling system for cooling the brush-slip ring device.

The invention is characterized by the following features:
fan blades are provided which are connected to the shaft in a torsion-proof manner and which comprise an air flow for supplying air to the brush-slip ring device.

The invention relates to an electric machine such as an electric motor or a generator, comprising a power supply device to the rotor by way of brushes and slip rings.

Slip rings for large rotating electric machines are currently still cooled by cooling air which is supplied from the outside. The cooling air can be supplied axially or radially. The cooling air is taken from the ambient environment, filtered, supplied to the brush-slip ring device, and thereafter guided through a brush dust filter and discharged again as hot exhaust air to the ambient environment.

Such external ventilating fans in the slip-ring cooling system are always a risk. When the fan or the voltage supplying the fan fails, the electric machine itself will also fail.

If slip-ring fans are not switched off immediately after standstill of the machine, or if they are not switched on again in the case of an idle hot machine, then thermal deformations may occur on the slip rings and the brush holders. This is the case for example when the cold cooling air flow is not distributed evenly among the hot slip rings when the machine is idle. When the machine is switched back on again, this may lead to thermal deformations and slip rings that run irregularly. This produces the so-called sparking of brushes with high wear and tear to the brushes and spark erosion on the slip ring.

A further problem of such external venting is the accumulation of dirt. Sealing gaps required as a result of construction are present in the slip ring. Electrically conductive brush dust will reach electrically critical regions with the cooling air flow and will be deposited there. Dirt will therefore accumulate over time in the slip-ring space. This leads to creepage paths and to a reduced insulation resistance of the rotor.

In the case of ventilation systems with brush dust filters disposed before the cooling air outlet of the machine there will be dust deposits on the brushes in the region of the brush dust filter because the filter is unable to completely absorb the entire brush dust. Such an accumulation of dirt is especially disturbing in hydroelectric power plants.

The invention is therefore based on the object of providing an electric machine according to the preamble of claim 1 in such a way that the brush-slip ring device is cooled in a flawless, reliable and perfect manner.

This object is achieved according to the characterizing part of claim 1.

Accordingly, fan blades are associated with the rotor shaft, which blades generate an air flow with the circulation of the rotor which is supplied in a purposeful manner to the brush-slip ring device.

This leads the following advantages:
The ventilation system in accordance with the invention is very simple from a constructional point of view. Blades which are punched from sheet metal are sufficient for example, which can be produced in a cost-effective way.
The cooling air flow is generated from the first moment of rotation of the rotor. It is therefore available immediately after start-up of the machine. After the standstill of the machine on the other hand, the cooling air flow will also be switched off. Thermal deformations and all problems in connection with this will therefore not occur.
There is no external cooling-air generation system and therefore no dependence on such a system.
No brush dust will be conveyed out of the slip-ring space. The slip-ring space will remain clean. Electrical problems by brush dust deposits will hardly occur or not at all.
The cooling air flow will be guided in a closed circuit, namely over a relatively short air-guidance path. The circuit is closed. Deposits of dirt by brush dust are therefore excluded from the environment of the machine.

The invention will be explained in closer detail by reference to the drawings, which show the following in detail:

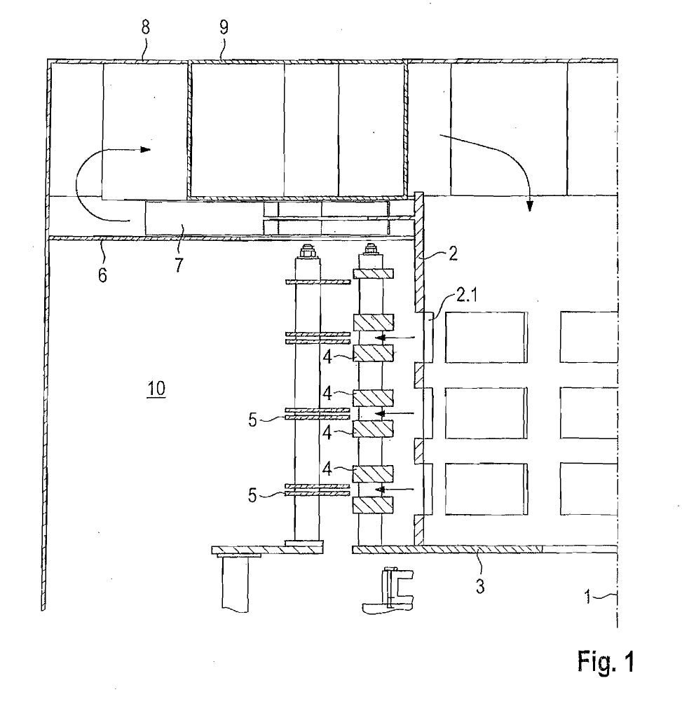

FIG. 1 shows an axial sectional view of the end region of an electric machine with a brush-slip ring device and a cooling device that belongs to the same;

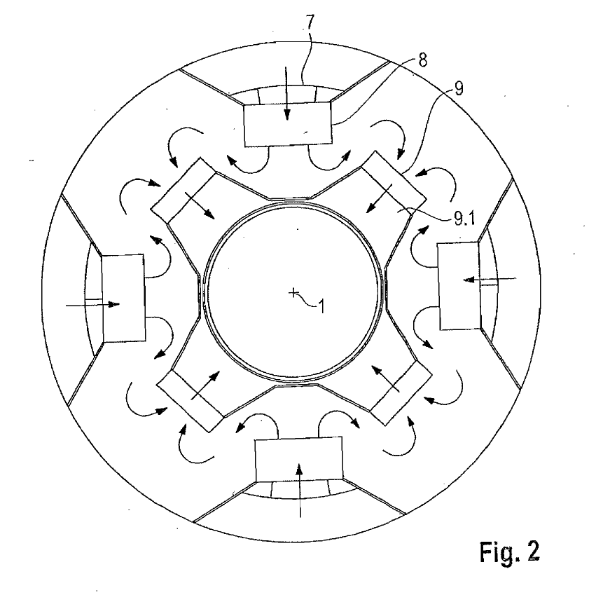

FIG. 2 shows a top view in a schematic device of the end region of an electric machine with a cooling device for a brush-slip ring device;

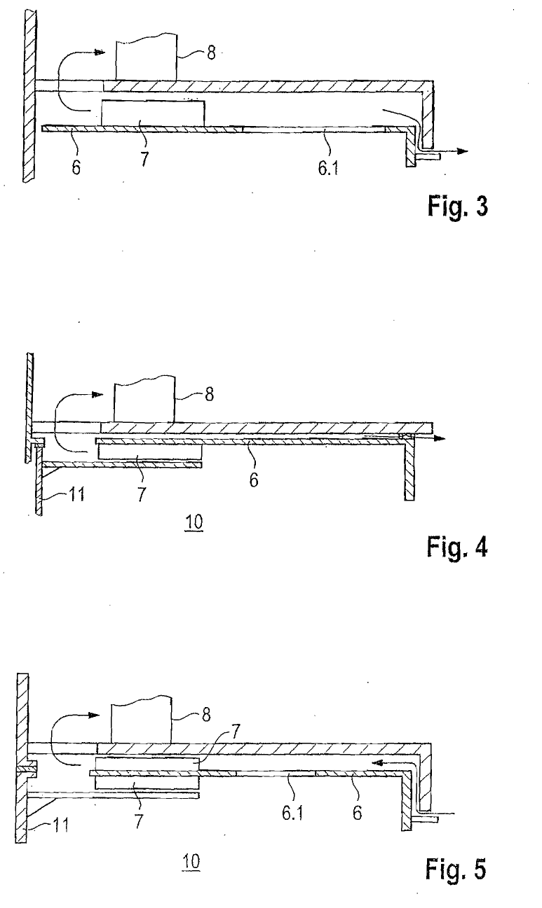

FIG. 3 shows an axial sectional view of details of a first embodiment of a cooling device in accordance with the invention;

FIG. 4 shows a second embodiment in analogy to FIG. 3;

FIG. 5 shows a third embodiment in analogy to FIG. 3;

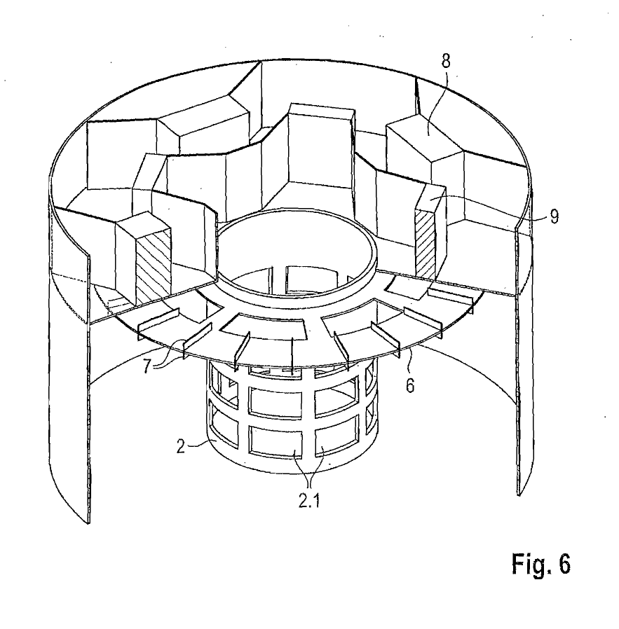

FIG. 6 shows a schematic perspective view, which is partly cut away, of relevant parts of a cooling device in accordance with the invention.

The following is shown in detail in FIG. 1:

The rotational axis 1 of the machine is enclosed by a distributing pipe 2. It comprises breakthroughs 2.1 on its circumference. The distributing pipe 2 carries an annular plate 3 on its face end. It carries a plurality of slip rings 4 which are disposed behind one another parallel to the axis of the machine and revolve with the rotor of the machine.

The brush holders 5 are rigidly connected with the fixed ambient environment and the stator housing. They carry the brushes (not shown). The slip space 10 is the entire space in which the slip rings 4 and the brushes with the brush holders 5 are disposed. It is delimited by the bottom cover disk 6. The cover disk is static.

The fan blades are relevant, of which blade 7 is shown here. Blade 7 is connected in a torsion-proof manner with the distributing pipe 2 and therefore revolves during operation of the machine.

The illustration further shows a filter 8 and a cooler 9.

The cooling air system in accordance with the invention works as follows:

The fan blades 7 generate an air flow. It reaches filter 8 at first, and then the cooler 9, thereafter the distributing pipe 2 and exits through the numerous breakthroughs 2.1 in form of individual jets. Both the slip rings 4 and also the brush holders 5 and the brushes themselves are subjected to the jets and are cooled.

FIG. 2 shows the rotational axis 1 of the machine again. The fan blades 7 are relevant. The illustration further shows the filter 8 and the cooler 9. It concerns an air-water cooler. Cooled and filtered air reaches horizontally to the center from the coolers 9 at the outlet from the cooler boxes 9.1, and from there further downwardly into the rotating distributing pipe 2. The air then flows into the slip-ring space 10 through the aforementioned breakthroughs 2.1.

In the embodiment according to FIG. 3, a fan blade 7 is shown which revolves together with the distributing pipe 2. The bottom non-revolving cover disk 6 of the fan blade 7 is disposed beneath the fan blade 7 (radial shaft fan). Cooling air which is loaded with brush dust reaches the fan blade 7 through an open circular surface which is formed by the bottom cover disk 6 and the distributing pipe 2. It conveys dust-containing heated air radially to the outside and further upwardly to the filters 8 (see the solid arrows). The air is still loaded with a low percentage of brush dust. It reaches from the filters 8 to the coolers 9, by means of which the circuit is closed. Notice shall be taken of the two circles which respectively designate a gap seal. The air passes through the gap seal in the filtered state, loaded with a low percentage of brush dust. The bottom cover disk 6 forms an additional seal against the outer wall 11 of the slip-ring space 10.

In the embodiment according to FIG. 4, the fan blades 7 are disposed on the bottom side of the bottom cover disk 6.

The embodiment according to FIG. 5 is especially advantageous. The bottom cover disk 6 carries fan blades 7 on both sides. The bottom cover disk 6 which carries the fan blade 7 has a breakthrough (see breakthrough 6.1), so that the coolant flow loaded with brush dust can be drawn off from the slip-ring space 10 in an unobstructed way. The fan blades draw in air through the gap seal irrespective of the type of the contactless seal (see the circle with the broken line again), which air is still loaded with a residual percentage of brush dust. This air will then be conveyed to the filters 8. As a result, any return conveyance of heated cooling air loaded with brush dust into the slip-ring space 10 is prevented.

The cover disks 6 comprise recesses 6.1 in the embodiment according to FIGS. 3 and 5.

The embodiment according to FIG. 6 shows the distributing pipe 2 again with its breakthroughs 2.1. The bottom cover disk 6 is connected in a torsion-proof manner with the distributing pipe 2. It carries a plurality of fan blades 7, namely on both of its sides.

The illustration further shows a number of filters 8 and coolers 9, and further the bottom cover disk 6.

### LIST OF REFERENCE NUMERALS

1 Rotational axis
2 Distributing pipe
2.1 Breakthroughs
3 Annular plate
4 Slip rings
5 Brush holders
6 Bottom cover disk
7 Fan blades
8 Filter
9 Cooler
9.1 Cooler boxes
10 Slip-ring space
11 Wall of the slip-ring space

1.-4. (canceled)

5. An electric machine comprising:
a stator;
a rotor carried by a shaft;
a brush-slip ring device, the slip ring of which encloses the shaft and is connected with said shaft in a torsion-proof manner;
a cooling system for cooling the brush-slip ring device;
with fan blades being provided which are connected to the shaft in a torsion-proof manner and which generate a cooling air flow for supplying air to the brush-slip ring device;
characterized in that
the cooling air flow is guided in a closed circuit.

6. The electric machine according to claim 5, characterized in that a cooler is provided in the closed cooling circuit.

7. The electric machine according to claim 6, characterized in that the cooler (9) is arranged as an air-water cooler.

8. The electric machine according to claim 5, characterized by the following features:
a distributing pipe is provided which is arranged coaxially to the rotational axis of the machine and comprises a plurality of breakthroughs;
the distributing pipe is enclosed by a number of slip rings and brush holders with brushes which are associated with said slip rings;
the breakthroughs are respectively disposed in the region of a set of slip rings and brushes.

9. The electric machine according to claim 6, characterized by the following features:
a distributing pipe is provided which is arranged coaxially to the rotational axis of the machine and comprises a plurality of breakthroughs;
the distributing pipe is enclosed by a number of slip rings and brush holders with brushes which are associated with said slip rings;
the breakthroughs are respectively disposed in the region of a set of slip rings and brushes.

10. The electric machine according to claim 7, characterized by the following features:
a distributing pipe is provided which is arranged coaxially to the rotational axis of the machine and comprises a plurality of breakthroughs;
the distributing pipe is enclosed by a number of slip rings and brush holders with brushes which are associated with said slip rings;
the breakthroughs are respectively disposed in the region of a set of slip rings and brushes.

11. The electric machine according to claim 8, characterized in that the distributing pipe comprises a cover disk which extends at a right angle relative to the rotational axis of the machine and which is connected to the distributing pipe in a torsion-proof way and carries the fan blades.

12. The electric machine according to claim 9, characterized in that the distributing pipe comprises a cover disk which extends at a right angle relative to the rotational axis of the machine and which is connected to the distributing pipe in a torsion-proof way and carries the fan blades.

13. The electric machine according to claim 10, characterized in that the distributing pipe comprises a cover disk which extends at a right angle relative to the rotational axis of the machine and which is connected to the distributing pipe in a torsion-proof way and carries the fan blades.

14. The electric machine according to claim 11, characterized in that the cover disk carries fan blades on its two lateral sides.

15. The electric machine according to claim 12, characterized in that the cover disk carries fan blades on its two lateral sides.

16. The electric machine according to claim 13, characterized in that the cover disk carries fan blades on its two lateral sides.
